(19) United States
(12) Patent Application Publication
(10) Pub. No.: US 2011/0126982 A1
(43) Pub. Date: Jun. 2, 2011

(54) Moisture Curable Adhesives

(76) Inventors: Robert Brian Lawrence, Germantown, TN (US); Yingjie Li, Batavia, IL (US); Frank Swiezkowski, Hamilton Square, NJ (US)

(21) Appl. No.: 12/957,842

(22) Filed: Dec. 1, 2010

Related U.S. Application Data
(60) Provisional application No. 61/265,908, filed on Dec. 2, 2009.

(51) Int. Cl. B32B 37/12; C08G 18/00; C08G 18/22; C08G 18/18; C08G 18/16

(52) U.S. Cl. 156/331.7; 528/44; 528/55; 528/52; 528/49

(57) ABSTRACT

The present invention relates to moisture curable reactive adhesive compositions containing a visual indicator and methods for using these compositions. Specifically, the invention relates to a two part moisture curable reactive adhesive system, where one part consists of a prepolymer with moisture reactive groups and the second part consists of catalyst, a visual indicator and water. The presence of the indicator allows the combination of the two part system to be visible to the naked eye. The visible indicator ensures that the two part system is combined uniformly and completely to a desired substrate, but it does not interfere with the crosslinking reaction.

### CROSS-REFERENCE TO RELATED APPLICATION

This application claims the benefit of U.S. Provisional Patent Application Ser. No. 61/265,908 filed Dec. 2, 2009, the contents of which are incorporated herein by reference.

### FIELD OF THE INVENTION

This invention relates to moisture curable adhesives containing a visual indicator, their use, and production.

### BACKGROUND OF THE INVENTION

Liquid moisture curable adhesives and sealants are typically thermosetting prepolymers with moisture reactive groups, such as isocyanate groups, which cure in the presence of moisture. Such adhesive and sealant systems have excellent adhesion to a variety of substrates and excellent resistance to chemicals and temperature variations.

Unlike polyurethane reactive hot melt, which typically contains a very small amount of unreacted isocyanate groups, liquid moisture curable polyurethane adhesives usually contain a higher concentration of unreacted isocyanate groups. Accordingly, an extra amount of moisture, in addition to ambient moisture levels, is usually introduced to ensure a consistent and complete crosslinking reaction. A catalyst is often added with the polyurethane to increase the curing speed of the adhesive. However, polyurethane formulated with catalyst has a short pot life and narrows the processing time. In order to extend the pot life and processing time, adhesive is typically formulated into two part system: one part consisting of a prepolymer with moisture reactive groups and the second part consisting of catalyst and water. The first part of the adhesive is applied onto a substrate and the second part is applied onto the first part, usually by misting onto the first part, to initiate the crosslinking reaction. It is critical, however, to apply a uniform and complete coverage of the second part onto the first part to ensure a consistent and complete crosslinking reaction. Unlike the polyurethane formulated with catalyst system where the catalyst is uniformly distributed, it is difficult to uniformly deposit the catalyst-water through misting.

Therefore a need exists in the art for a moisture curable reactive adhesive composition that provides for a well controlled and a uniform curing.

### BRIEF SUMMARY OF THE INVENTION

The invention provides moisture curable reactive adhesive compositions containing a visual indicator and a method for using these compositions. The visual indictor in the moisture curable reactive ensures that the adhesive is applied evenly and completely to a desired substrate, without interfering with the crosslinking reaction.

One embodiment of the invention is directed to a two-component moisture curable system comprising (1) a first component as a polyurethane prepolymer with moisture curable groups; and (2) a second component comprising a water soluble and/or water dispersible catalyst and a visual indicator in water.

In another embodiment, the concentration of the water soluble and/or water dispersible catalyst in the second component ranges from about 0.5wt % to 50 wt %.

In a further embodiment, the concentration of the visual indicator in the second component ranges from about 0.1 wt % to about 50 wt %

Yet another embodiment is directed to a method of applying a first component comprising a polyurethane prepolymer with moisture curable groups to a first substrate; applying a second component comprising a mixture of a water soluble and/or water dispersible catalyst and a visual indicator in water onto the first component; bringing a second substrate in contact with the first substrate on the side with the two components; and subjecting the applied components to cure and form a set bond.

Another embodiment is directed to applying the first component comprising a polyurethane prepolymer with moisture curable groups to a first substrate; applying a second component comprising a mixture of a water soluble and/or water dispersible catalyst and a visual indicator in water onto a second substrate component; joining the two substrates together at the applied sites; and subjecting the applied components to cure and form a set bond.

A further embodiment of the invention is directed to an article of manufacture prepared using the two component moisture curable system.

### DETAILED DESCRIPTION OF THE INVENTION

The invention concerns novel compositions and methods useful for providing a visual indication of the combined two part moisture curable reactive adhesive system. A visual indicator in the adhesive has the advantage of allowing the user to combine the two part adhesive evenly and uniformly on the substrate as well as to completely cover the entire substrate.

The disclosures of all documents cited herein are incorporated in their entireties by reference.

The two-component moisture curable system comprises polyurethane prepolymer with moisture curable groups in one component and the second component comprises a water soluble and/or water dispersible catalyst and a visual indicator in water.

The polyurethane prepolymer with moisture curable groups is prepared by the polymerization of a polyisocyanate with a polyol. The polyols used include polyhydroxy ethers (substituted or unsubstituted polyalkylene ether glycols or polyhydroxy polyalkylene ethers), polyhydroxy polyesters, the ethylene or propylene oxide adducts of polyols and the monosubstituted esters of glycerol, as well as mixtures thereof. The polyol is typically used in an amount of between about 20 to about 85 parts by weight.

Polyisocyanate compounds useful in the practice of this invention include 1,4-diisocyanatobenzene (PPDI), toluene diisocyanate (TDI), 4,4′-diphenylmethane diisocyanate (4,4′-MDI), 2,4′-diphenylmethane diisocyanate (2,4′-MDI), polymethylene poly(phenyl isocyanate) (PMDI), 1,5-naphthalene diisocyanate (NDI), bitolylene diisocyanate (TODI), 1,3-xylene diisocyanate (XDI), p-1,1,4,4-tetramethylxylene diisocyanate (p-TMXI), m-1,1,3,3-tetramethylxylylene diisocyanate (m-TMXDI), 1,6-diisocyanato-2,4,4-trimethylhexane, 1,4-cyclohexane diisocyanate (CHDI), 1,4-cyclohexanebis(methylene isocyanate) (BDI), 1,3-bis(isocyanatomethyl) cyclohexane (H₆XDI), 3-isocyanatomethyl-3,5,5-trimethylcyclohexyl isocyanate (IPDI), dicyclohexylmethane diisocyanate (H₁₂MDI), triphenylmethane-4,4′,4″-triisocyanate, oligomeric isocyanate with functionality greater than 2.0 and the like. Mixtures of polyisocyanates, e.g., 2,4′-MDI and 4,4′-MDI, may be used. Optionally, modified polyisocyanates such as isocyanate-terminated prepolymers prepared by reacting any of the above polyisocyanates with a substoichiometric amount of an isocyanate-reactive compound may be used. Suitable organic compounds for the formation of prepolymers include, for example, polyether polyols or polyester polyols which contain 1 to 4 hydroxyl groups and have molecular weights of from about 60 to about 1, 400. While such compounds are commercially available, methods for synthesizing such compounds are well known in the art. Preferred isocyanate-containing compounds are methylenebisphenyldiisocyanate (MDI), isophoronediisocyanate (IPDI) and toluene diisocyanate (TDI), based on higher isocyanate functionality and their polymeric analogues.

The amount of polyisocyanate will typically represent from about 15 to about 80, preferably from about 20 to about 60, weight percent of the moisture curable adhesive of this invention.

The polyol is generally chosen from polyether polyols, polyester polyols and unsaturated polyols. The polyether polyols are generally chosen from aliphatic and aromatic polyether polyols and mixtures of these compounds. Their average molecular mass is preferably between 200 and 9000 and their hydroxyl functionality is preferably between 2 and 4.6.

Examples of polyether polyols include a linear and/or branched polyether having plural numbers of ether bondings and at least two hydroxyl groups, and contain substantially no functional group other than the hydroxyl groups. Examples of the polyether polyol may include polyoxyalkylene polyol such as polyethylene glycol, polypropylene glycol, polybutadiene diols, polybutylene glycol, caster oil and the like. Further, a homopolymer and a copolymer of the polyoxyalkylene polyols may also be employed. Particularly preferable copolymers of the polyoxyalkylene polyols may include an adduct at least one compound selected from the group consisting of ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl) propane, triethanolamine, triisopropanolamine, ethylenediamine and ethanolamine; with at least one compound selected from the group consisting of ethylene oxide, propylene oxide and butylene oxide.

Polyester polyols are formed from the condensation of one or more polyhydric alcohols having from 2 to 15 carbon atoms with one or more polycarboxylic acids having from 2 to 14 carbon atoms. Examples of suitable polyhydric alcohols include ethylene glycol, propylene glycol such as 1,2-propylene glycol and 1,3-propylene glycol, glycerol, pentaerythritol, trimethylolpropane, 1,4,6-octanetriol, butanediol, pentanediol, hexanediol, dodecanediol, octanediol, chloropentanediol, glycerol monallyl ether, glycerol monoethyl ether, diethylene glycol, 2-ethylhexanediol-1,4, cyclohexanediol-1,4, 1,2,6-hexanetriol, 1,3,5-hexanetriol, 1,3-bis(2-hydroxyethoxy)propane and the like. Examples of polycarboxylic acids include phthalic acid, isophthalic acid, terephthalic acid, tetrachlorophthalic acid, maleic acid, dodecylmaleic acid, octadecenylmaleic acid, fumaric acid, aconitic acid, trimellitic acid, tricarballylic acid, 3,3′-thiodipropionic acid, succinic acid, adipic acid, malonic acid, glutaric acid, pimelic acid, sebacic acid, cyclohexane-1,2-dicarboxylic acid, 1,4-cyclohexadiene-1,2-dicarboxylic acid, 3-methyl-3,5-cyclohexadiene-1,2-dicarboxylic acid and the corresponding acid anhydrides, acid chlorides and acid esters such as phthalic anhydride, phthaloyl chloride and the dimethyl ester of phthalic acid. Preferred polycarboxylic acids are the aliphatic and cycloaliphatic dicarboxylic acids containing no more than 14 carbon atoms and the aromatic dicarboxylic acids containing no more than 14 atoms.

The unsaturated polyols are generally chosen from polyols and mixtures of polyols preferably having a molecular mass of between 500 and 6000. Mention may be made, by way of examples, of polybutadiene and polyisoprene containing hydroxylated endings. The abovementioned polyols are advantageously amorphous. The abovementioned polyols can also be used as a mixture with other hydroxylated compounds. It is thus possible to use a monool or a mixture of monools, in particular poly(ethylene/butylene)monools, such as Kraton Liquid® L-1203 Polymer, sold by the company Shell, or a polyol or a mixture of polyols chosen from poly(ethylene/butylene)diols, such as Kraton Liquid® polymer HPVM-2203, sold by Shell, copolymers of ethylene, of vinyl acetate and of 2-hydroxyethyl acrylate, such as Orevac® 9402, sold by Elf Atochem, indene/coumarone resins modified by phenol, for example Novares CA120, sold by VFT, and hydroxylated tackifying resins, for example Reagem, sold by DRT. The abovementioned monool and the abovementioned polyol respectively represent 0 to 10% and 0 to 25% by weight of the polyols.

Although compounds conventionally known as a urethane prepolymer are those having comparatively low molecular weight, a person with ordinary skill in the art knows that a compound having an average molecular weight (Mn) in the order of several tens of thousands can also be a urethane prepolymer in addition to a urethane prepolymer having the low molecular weight. Accordingly, in the present invention, a urethane prepolymer having an average molecular weight (Mn) of several tens of thousands can also be used as a prepolymer.

The moisture-crosslinkable adhesive according to the invention can comprise conventional additives known to a person skilled in the art, such as fillers, tackifying agents, plasticizers, adhesion promoters, such as compounds containing silanyl groups, plasticizers, fillers, anti-oxidants, defoamers, rehology modifiers, stabilizers, aliphatic C₅-C₁₀terpene oligomers, solvents, petroleum distilate and the like. Conventional additives which are compatible with a composition according to this invention may simply be determined by combining a potential additive with the composition and determining if they are compatible. An additive is compatible if it is homogenous within the product. Non-limiting examples of suitable additives include, without limitation, rosin, rosin derivatives, rosin ester, flame retardants, aliphatic hydrocarbons, aromatic hydrocarbons, aromatically modified aliphatic hydrocarbons, terpenes, terpene phenol, modified terpene, high molecular weight hindered phenols and multifunctional phenols such as sulfur and phosphorous-containing phenol, terpene oligomers, paraffin waxes, microcrystalline waxes and hydrogenated castor oil.

The second component of the two component moisture curable adhesive composition comprises a water soluble and/or water dispersible catalyst and a water soluble and/or water dispersible visual indicator in water.

Useful water soluble catalyst, from room temperature to about 40° C. and at atmospheric pressure, has a concentration range of from about 0.5 to about 50 (wt/wt) %, preferably from about 2.5 to about 35 (wt/wt) %, more preferably from about 3.0 to 25 (wt/wt) %. In another embodiment, water dispersible catalyst with also a concentration range of about 0.5 to about 50 (wt/wt) %, preferably from about 2.5 to about 35 (wt/wt) %, more preferably from about 3.0 to 25 (wt/wt) % may be utilized in the second component. Water dispersible catalyst, although not soluble in water, forms colloids or suspensions in water. Surfactants and/or additives made be added to with the catalyst to increase the solubility and dispersibility in water. Moreover, a catalyst that is insoluble or has low water dispersibility, may still be used in the second component if it is vigorously mixed and agitated just prior to use.

Exemplary water soluble and/or water dispersible catalyst is selected from the group consisting of heavy metals such as dialkyltin dicarboxylates, zirconium complex, aluminum chelates, titanic chelates, Zn, Co, Ni, Fe, and the like, amine such as secondary amines, tertiary amines, stannous salts of carboxylic acids, and the like. Preferred water soluble and/or water dispersible catalyst are commercially available from Huntsman, as listed in JEFFCAT Amine Catalyst Brochure, Huntsman Corporation 2007, including tertiary amine is 2,2′-dimorpholinodiethylether, bis(2-dimethylaminoethyl)ether, N,N,N′-trimethyl-N-hydroxyethyl-bisaminoethyl ether, N,N-bis(3-dimethylaminopropyl)-N-isopropanol amine, N-(3-dimethylaminopropyl)-N,N-diisopropanolamine, N,N-dimethylethanolamine, 2-(2-dimethylaminoethoxy) ethanol, benzyldimethylamine, N,N-dimethylcyclohexylamine, 1,3-propanedimaine N′-(3-dimethylamino)propyl)-N,N-dimethyl, N,N,N′-trimethylaminoethyl-ethanolamine, N-ethylmorpholine, 1,3,5-tris(3-dimehtylamino)propyl)-hexahydro-s-triazine and mixtures thereof. Particularly preferred water soluble and/or water dispersible catalyst is a non-fugitive tertiary amine. Additives may be added to the water soluble and/or water dispersible catalyst in order to decrease the volatility of the catalyst.

Although the primary amount of catalyst is in the second component, small amount of catalyst, up to 0.5 (wt/wt) % may be incorporated in the first component with the urethane prepolymer. The first component, urethane prepolymer, may also be essentially free of the catalyst, where essentially free is defined as less than 0.2 (wt/wt) %.

The second component further comprises a water soluble and/or water dispersible visual indicator in water. The visual indicator and/or colorant, herein used interchangeably, is a substance that imparts color to a material. Visual indicator may be in the form of a dye and/or a pigment.

Dyes and pigments are classified by Colour Index International by their chemical class (see The Chemistry and Application of Dyes by David R. Waring and Geoffrey Hallas 1990). Exemplary dyes and pigments, as defined by Colour Index International, are in the chemical class of nitroso, nitro, monoazo, disazo, triaszo, polyazo, azoic, stibene, carotenoid, diphenylmethane, triarylmethane, xanthene, acridine, quinoline, methine, thiazole, indamine, azine, oxazine, thiazine, sulphur, lactone, aminoketone, hydroxyketone, anthraquinone, indigoid, phthalocyanine, oxidation base, inorganic and natural groups.

The dyes are usually water soluble, surfactants can be added to increase its solubility. Preferable dyes for use in the invention, at room temperature to about 40° C. and at atmospheric pressure, has a concentration range of from about 0.1 to about 50 (wt/wt) %, preferably from about 1.0 to about 10 (wt/wt) %. A pigment, with the same concentrations may also be used in the second component as the visual indicator. The pigments are generally not soluble in water, and may be dispersed in water in the second component to form colloids or in suspensions in water. Surfactants and/or additives may be added to with the pigment to increase its dispersibility in water. Moreover, a visual indicator that is water insoluble or has low water dispersibility, still may be used if it is vigorous mixed and agitated just prior to use. Preferred visual indicator is a dye. Particularly preferred dye is are in the family of food grade, acid, basic, direct, pigment, reactive, fluorescent brighteners and solvent according to the Colour Index International.

When the two components come in contact with each other, the isocyanate of the first component reacts with the water of the second component and immediately starts the crosslinking reaction.

The invention also provides a method for bonding articles together which comprises applying the first component, polyurethane prepolymer, of the moisture curable adhesive composition of the invention in a liquid melt form to a first substrate, applying the second component onto the first component, contacting a second substrate with the composition applied to the first substrate, and subjecting the applied composition to conditions which will allow the composition to cure irreversibly.

The first component is typically distributed and stored in the absence of moisture. The first component is typically roll-coated onto a substrate. The second component is then applied, typically sprayed or misted, onto the applied first component. In another embodiment, the first component is applied onto a first substrate and the second component is applied onto a second substrate, and the two substrates are then joined together at the applied sites of the substrates.

The visual indicator of the second component serves to guarantee that the desired area has been treated and the proper amount of the second component is applied. The visual indicator of the subject invention can be used to improve uniform curing of the adhesive. For example, the accuracy of the spray is often unreliable; therefore this visual indictor formulated second component is quite advantageous because the visual indicator makes certain that the desired area is entirely and uniformly covered.

Once the second component adequately covers the applied first component, a second substrate is placed on top of the first applied component. The combined two component adhesive is then subjected to conditions that will allow it to solidify and cure to a composition that has an irreversible solid form.

The moisture curable adhesive compositions of the invention are useful for bonding articles composed of a wide variety of substrates (materials), including but not limited to foam, wood, metal, polymeric plastics, composite, glass and textiles. As such, these adhesives find particular use in bonding to exterior surfaces, bonding to wood with high levels of pitch and e.g., in marine and automotive applications. Other non-limiting uses include textile bonding applications (carpet and clothing), use in the manufacture of footwear (shoes), use as a glazing/backbedding compound in the manufacture of windows, use in the manufacture of doors including entry doors, garage doors and the like, use in the manufacture of architectural panels, recreational vehicle panels, construction panels, use in bonding components on the exterior of vehicles, and the like.

The invention is further illustrated by the following non-limiting examples.

### EXAMPLES

The polyurethane prepolymer with moisture curable groups, first component, was Macroplast UR 8340 (Henkel Corporation, Bridgewater, N.J.).

The second component was made of a catalyst and a visual indicator (type and concentration listed in Table 1) in water.

TABLE 1

| | | Catalyst | | Visual |
|---|---|---|---|---|
| Ex- | | Concen- | | Indicator |
| am- | | tration | | Concentration |
| ple | Catalyst | (wt/wt) % | Visual Indicator | (wt/wt) % |
| 1 | ZR-40 ^{a} | 5 | FD&C Red #40 ^{b} | 1 |
| 2 | ZR-40 ^{a} | 5 | Blue Liquid Color L-0693 ^{c} | 1 |
| 3 | ZR-40 ^{a} | 5 | Aurasperse Phthalocyanine | 1 |
| | | | Blue W 4123 ^{d} | |
| 4 | ZR-40 ^{a} | 5 | FD&C Red #40 ^{b} | 5 |
| 5 | ZR-40 ^{a} | 5 | FD&C Red #40 ^{b} | 10 |
| 6 | ZF-10 ^{a} | 5 | FD&C Red #40 ^{b} | 1 |
| 7 | ZF-10 ^{a} | 5 | Blue Liquid Color L-0693 ^{c} | 1 |
| | | | Aurasperse Phthalocyanine | |
| 8 | ZF-10 ^{a} | 5 | Blue W 4123 ^{d} | 1 |

^{a} JEFFCAT ® catalyst, Huntsman Corporation, Woodlands, TX
^{b} Sensient Colors Inc., Milwaukee, WI
^{c} Prime Ingredients Inc., Saddle Brook, NJ
^{d} Engelhard Corporation, Iselin, NJ

A 15-20 gram coat weight of first component was applied onto a 12″×12″ plywood with a 5/16″ threaded rod. Onto the applied particle board, a second component was sprayed onto the first component using a Portable Spray Gun (Preval) until it was uniformly and completely covered. The coverage was visible because the treated area cleared showed a color change.

The adhesive cured completely in approximately 50-55 minutes without any tack.

A comparative sample, without any second component, formed a skin but remained tacky underneath the skin even after 55 minutes.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A two-component moisture curable system comprising:
a. a first component comprising a polyurethane prepolymer having moisture curable groups; and
b. a second component comprising a water soluble and/or water dispersible catalyst, a visual indicator; and water.

2. The two-component moisture curable system of claim 1, wherein the first component is essentially free of a catalyst.

3. The two-component moisture curable system of claim 1, wherein the catalyst in the second component is selected from the group consisting of heavy metals, secondary amines, tertiary amines, and tannous salts of carboxylic acids.

4. The two-component moisture curable system of claim 3, wherein the catalyst is selected from tertiary amines.

5. The two-component moisture curable system of claim 4, wherein the tertiary amine is 2,2′-dimorpholinodiethylether, bis(2-dimethylaminoethyl)ether, N,N,N′-trimethyl-N-hydroxyethyl-bisaminoethyl ether, N,N-bis(3-dimethylaminopropyl)-N-isopropanol amine, N-(3-dimethylaminopropyl)-N,N-diisopropanolamine, N,N-dimethylethanolamine, 2-(2-dimethylaminoethoxy) ethanol, benzyldimethylamine, N,N-dimethylcyclohexylamine, 1,3-propanedimaine N′-(3-dimethylamino)propyl)-N,N-dimethyl, N,N,N′-trimethylaminoethyl-ethanolamine, N-ethylmorpholine, 1,3,5-tris(3-dimehtylamino)propyl)-hexahydro-s-triazine or mixtures thereof.

6. The two-component moisture curable system of claim 5, wherein the tertiary amine is 2,2′-dimorpholinodiethylether, bis(2-dimethylaminoethyl)ether, N,N,N′-trimethyl-N-hydroxyethyl-bisaminoethyl ether, N,N-bis(3-dimethylaminopropyl)-N-isopropanol amine, N-(3-dimethylaminopropyl)-N,N-diisopropanolamine, N,N-dimethylethanolamine, 2-(2-dimethylaminoethoxy) ethanol or mixtures thereof.

7. The two-component moisture curable system of claim 1, wherein the effective concentration of the water soluble and/or water dispersible catalyst is from about 0.5 (wt/wt) % to about 50 (wt/wt) %% in the second component.

8. The two-component moisture curable system of claim 7, wherein the effective concentration of the water soluble and/or water dispersible catalyst is from about 2.5 (wt/wt) % to about 35 (wt/wt) % in the second component.

9. The two-component moisture curable system of claim 8, wherein the effective concentration of the water soluble and/or water dispersible catalyst is from about 3 (wt/wt) % to about 25 (wt/wt) % in the second component.

10. The two-component moisture curable system of claim 9, wherein the effective concentration of the visual indictor is from about 0.1 (wt/wt) % to about 50 (wt/wt) % in the second component.

11. The two-component moisture curable system of claim 1, wherein the visual indicator is selected from the group consisting of pigment, dye or mixtures thereof.

12. The two-component moisture curable system of claim 11, wherein the visual indicator is a dye.

13. The two-component moisture curable system of claim 1, wherein the effective concentration of the visual indicator is from about 0.1 (wt/wt) % to about 10 (wt/wt) % in the second component.

14. The two-component moisture curable system of claim 1, further comprising a surfactant in the second component.

15. A method of bonding substrates together which comprises:
a. applying a first component comprising a polyurethane prepolymer with moisture curable groups to a first substrate;
b. applying a second component comprising a mixture of a water soluble and/or water dispersible catalyst, a visual indicator, and water onto the first component;
c. bringing a second substrate in contact with the first substrate on the side with the two components; and
d. subjecting the applied components to cure and form a set bond.

16. The method of claim 15, wherein the first component is applied by roll-coating and the second component is applied by spraying.

17. The method of claim 15, wherein the substrate is a foam, wood, metal, polymeric plastics, composite, glass and textiles.

18. A method of bonding substrates together which comprises:
a. applying a first component comprising a polyurethane prepolymer with moisture curable groups to a first substrate;
b. applying a second component comprising a mixture of a water soluble and/or water dispersible catalyst, a visual indicator, and water onto a second substrate;
c. joining the first substrate and the second substrate to combine the first component and the second components; and
d. subjecting the applied components to cure and form a set bond.

19. An article of manufacture prepared using the adhesive of claim 1.

20. The article of claim 19 which is a windows, doors, shoes or panels.
